(19) United States
(12) Patent Application Publication
(10) Pub. No.: US 2026/0332515 A1
(43) Pub. Date: Oct. 22, 2026

(54) METHODS AND APPARATUS FOR TABLE-FREE DYNAMIC ROUTE MATCHING FOR COMMUNICATION NETWORKS

(71) Applicant: Selector Software, Inc., Santa Clara, CA (US)

(72) Inventors: Sunanda Kommula, Cupertino, CA (US); Nitin Kumar, Fremont, CA (US); Siva Gaggara, Hyderabad (IN)

(21) Appl. No.: 19/182,891

(22) Filed: Apr. 18, 2025

(51) Int. Cl. H04L 45/24; H04L 45/02; H04L 47/17

(52) U.S. Cl. CPC H04L 45/24; H04L 45/02; H04L 47/17

(57) ABSTRACT

This disclosure pertains to computer-assisted methods, apparatus, and systems for efficiently monitoring and storing the state of large-scale communication networks and tracing packet routes through such networks.

### FIELD OF THE INVENTION

This disclosure pertains to computer-assisted methods, apparatus, and systems for efficiently monitoring and re-creating the state of a large-scale communication network and tracing packet routes through such networks.

### BACKGROUND

Currently, the Internet comprises about one million IPv4 nodes, each node having a “prefix”, i.e., an Internet Protocol (IP) address (or portion of an address). (The Internet also has IPv6 destinations, IPv6 having been developed to, inter alia, address the IPV4 address exhaustion problem, and both protocols currently coexist on the internet.) Furthermore, a large scale Internet Service Provider (ISP) serving millions of customers located in a multitude of different countries and continents may maintain upwards of several thousand Provider Edge routers (PEs) located all over the world.

To generally provide its customers fast, smooth, and error-free access to the Internet, such ISPs must monitor the condition of their networks continuously to assure proper operation, detect and remedy failed nodes, detect traffic conditions and reroute traffic as needed to alleviate high traffic conditions, etc.

Part of this process of maintaining and monitoring a communication network is to maintain a routing table (or Routing Information Base; RIB, for short). Particularly, in a mesh network, such as the Internet, a routing table is developed over a period of time that dictates how any given packet will be routed through the network from any given source node to any given destination node. More particularly, to build the RIB, the nodes of the network exchange control plane messages (layer 1, 2, and/or 3 messages, such as prefix advertisement and discovery messages, etc.) whereby the nodes, over time, determine the complete topology of the network, including, for instance, which nodes are directly coupled to which other nodes and the cost of each connection between adjacent nodes. Some well-known protocols for advertisement and discovery of network topology data include OSPF (Open Shortest Path First) protocol, ISIS (Intermediate System to Intermediate System) protocol, and BGP (Border Gateway Protocol). The vast majority of all current networks use one or more of these three protocols. Typically, each node first exchanges messages to determine the nodes to which it is directly coupled (i.e., via one hop). Then the various nodes of the network exchange that information with additional nodes until every node in the network has a complete picture of the topology of the network.

FIG. 1 is a graphical representation of an exemplary network topology 10. It shows every node in the network as well as the links between the nodes and the cost of each link. In this simple example, there are 11 nodes, namely, nodes A through K. Each arrowed line represents a direct communication link between two nodes (i.e., two nodes that can communicate directly with one another without using an intermediate node, sometimes referred to as adjacent nodes). The arrows indicate the directions of the links, and the number in the middle of each line represents the relative cost of the link.

Once the network topology is mapped and known by each node, each node can build a Routing Information Base (RIB) which dictates to which other network node the node should transmit a data packet intended for any particular destination address. Particularly, each data packet typically includes within the packet a destination address (i.e., the identity of the destination node and/or device). The node determines the nexthop for the packet (i.e., the next node to which it should transmit the packet) based on the RIB and the destination address. The data packet may be either generated at the node including at one of the computing devices coupled to the node) (in which case the node is called the source or originating node) or received from another node for relay to yet another node (in which case the node is called an intermediate or relay node).

The RIB is largely based on the network topology (including the interconnectivity of the network nodes and the cost associated with each hop). Various algorithms are known for building RIBs. One such algorithm is Dijkstra's Shortest-Path-First algorithm. This particular algorithm attempts to determine the best route through the network from a given source node to a given destination node based primarily on a combination of the shortest path from the source node to the destination node and the lowest cost. In addition to the network topology, the exact route that a packet takes through the network may also be dependent upon the content of the packet. For instance, video data may be sent along a different path than a short message or high priority data may travel along a different path than lower priority data. Thus, in some cases, the RIB may identify more than one potential path that the data may take through the network, and the path will be selected from those potential paths identified in the RIB by an additional piece of information external of the RIB (e.g., the type of the data or the hardware configuration of the relevant router).

As new nodes are added or old nodes are removed from the network, update messages are exchanged so that all of the nodes can continuously update their picture of the network topology and their respective routing tables.

Referring again to the network topology diagram of FIG. 1, it also demonstrates a route, represented by the dashed line 12, dictated by the RIB for data originating at a first, source device 14 (e.g., a cellular telephone) that connects to the network via network node A and a second, destination device 16 (e.g., a server) that is connected to the network through node K. As can be seen, using an algorithm such as the aforementioned Dijkstra's algorithm, the RIB dictates a path that goes from node A to node D, then from node D to node E, then from node E to node F, and, finally, from node F to node K.

Effectively monitoring a large-scale nationwide ISP's network poses significant challenges, particularly in maintaining the RIB of thousands of PE routers. As alluded to above, the dynamic nature of the routing state, influenced by a user's location in reaching global Internet destinations, results in each PE's RIB holding a prefix pointing to a distinct nexthop as a function of the destination address of the data packet. Given the expansive size of the current Internet routing table, approximately 1 million prefixes, and assuming 5000 PEs within a major ISP, the task of maintaining and monitoring the RIB for a large-scale ISP's network involves monitoring a staggering 5 billion prefixes to capture the network's instantaneous perspective.

### SUMMARY

In an embodiment, a computer-readable device comprising non-transitory instructions, which, when executed by a processor, cause the processor to perform the operations of: receiving a query identifying a source device in a communication network, a destination device in the communication network, and a time of interest, T1; accessing a snapshot of a state of the communication network at a time, T0, preceding the time of interest, the snapshot comprising a topology of the communication network and a Routing Information Base (RIB) of the communication network at time T0; generating, based on the snapshot of the communication network, a RIB and a topology of the communication network at time T0; determining, based on the generated RIB and topology of the communication network, at one or more potential paths through the communication network that a data packet intended for transmission from the source device to the destination device could have traversed; accessing a set of network updates, the set of network updates comprising all updates to the topology and RIB of the communication network that occurred between time T0 and time T1 that have a prefix matching a specified portion of a prefix of the destination device; determining if any of the accessed network updates could have altered a nexthop or path attribute of a node in the one or more potential paths; if it was determined that one or more of the accessed network updates could have altered a nexthop or path attribute of a node in the one or more potential paths, applying Longest Prefix Matching (LPM) on only those of the determined network updates that could have altered a nexthop or path attribute of a node in the one or more potential paths to identify possible updated paths through the communication network that a data packet intended for transmission from the source device to the destination device could have traversed; if it was determined that one or more of the accessed network updates could have altered a nexthop or path attribute of a node in the one or more potential paths, determining, one or more potential substitute paths through the communication network that a data packet intended for transmission from the source device to the destination device could have traversed; and, if it was not determined that one or more of the accessed network updates could have altered a nexthop or path attribute of a node in the one or more potential paths, determining, based on the RIB and topology of the communication network of the snapshot, at least one or more potential paths through the communication network that a data packet intended for transmission from the source device to the destination device could have traversed.

In another embodiment, a method of determining a path that a data packet could have taken through a communication network at a time of interest comprises: receiving a query identifying a source device in a communication network, a destination device in the communication network, and a time of interest, T1; accessing a snapshot of a state of the communication network at a time, T0, preceding the time of interest, the snapshot comprising a topology of the communication network and a Routing Information Base (RIB) of the communication network at time T0; generating, based on the snapshot of the communication network, a RIB and a topology of the communication network at time T0; determining, based on the generated RIB and topology of the communication network, one or more potential paths through the communication network that a data packet intended for transmission from the source device to the destination device could have traversed; accessing a set of network updates, the set of network updates comprising all updates to the topology and RIB of the communication network that occurred between time T0 and time T1 that have a prefix matching a specified portion of a prefix of the destination device; determining if any of the accessed network updates could have altered a nexthop or path attribute of a node in the one or more potential paths; if it was determined that one or more of the accessed network updates could have altered a nexthop or path attribute of a node in the one or more potential paths, applying Longest Prefix Matching (LPM) on only those of the determined network updates that could have altered a nexthop or path attribute of a node in the one or more potential paths to identify possible updated paths through the communication network that a data packet intended for transmission from the source device to the destination device could have traversed; if it was determined that one or more of the accessed network updates could have altered a nexthop or path attribute of a node in the one or more potential paths, determining one or more potential substitute paths through the communication network that a data packet intended for transmission from the source device to the destination device could have traversed from the one or more potential substitute paths; and, if it was not determined that one or more of the accessed network updates could have altered a nexthop or path attribute of a node in the one or more potential paths, determining, based on the RIB and topology of the communication network of the snapshot, one or more potential paths through the communication network that a data packet intended for transmission from the source device to the destination device could have traversed.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements.

FIG. 1 is a diagram illustrating an exemplary network topology and packet route through the network;

FIG. 2 is a timing diagram graphically illustrating various timing aspects of re-creating the state of the network at a given time;

FIG. 3 is a timing diagram graphically illustrating various timing aspects of re-creating the state of the network at a given time in accordance with embodiments;

FIG. 4 is a graphical representation of at least a portion of the information that may be stored in a GIP table in accordance with embodiments;

FIG. 5 is a flowchart illustrating operation of a network monitoring tool in accordance with embodiments; and

FIGS. 6A-6D are diagrams showing the state of a table of potential bestpaths maintained according to an exemplary embodiment at four different stages of the process.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obfuscate the following description. Further, embodiments and examples not specifically described herein may be practiced in lieu of, or in combination with, the embodiments and other examples described, disclosed, or otherwise provided explicitly, implicitly, and/or inherently (collectively “provided”) herein.

Identifying the location of a faulty node in a communication network that is causing a problem with the orderly transfer of data within the network can be an enormously time consuming task, especially when the problem is reported or looked into hours or more after the problem occurred. As previously noted, when two computing devices exchange data over a network, the data is usually transported in discrete packets, wherein each packet travels along a path from the source node to the destination node via one or more intermediate nodes (hereinafter relay nodes). In a mesh network, a routing table is developed over a period of time that dictates how any given packet will be routed through the network from any given source node to any given destination node. More particularly, the nodes of the network exchange control plane messages (layer 1, 2, and/or 3 messages, such as prefix advertisement and discovery messages, etc.) whereby the nodes, over time, determine the complete topology of the network, including, for instance, which nodes are directly couple to which other nodes and the cost of each connection between adjacent nodes. Some well-known protocols for advertisement and discovery of network topology data are OSPF (Open Shortest Path First) protocol, ISIS (Intermediate System to Intermediate System) protocol, and BGP (Border Gateway Protocol). The vast majority of all current networks use one or more of these three protocols. Typically, each node first exchanges messages to determine to which other nodes it is directly coupled (i.e., via one hop). Then the various nodes of the network exchange that information with additional nodes until every node in the network has a complete picture of the topology of the network.

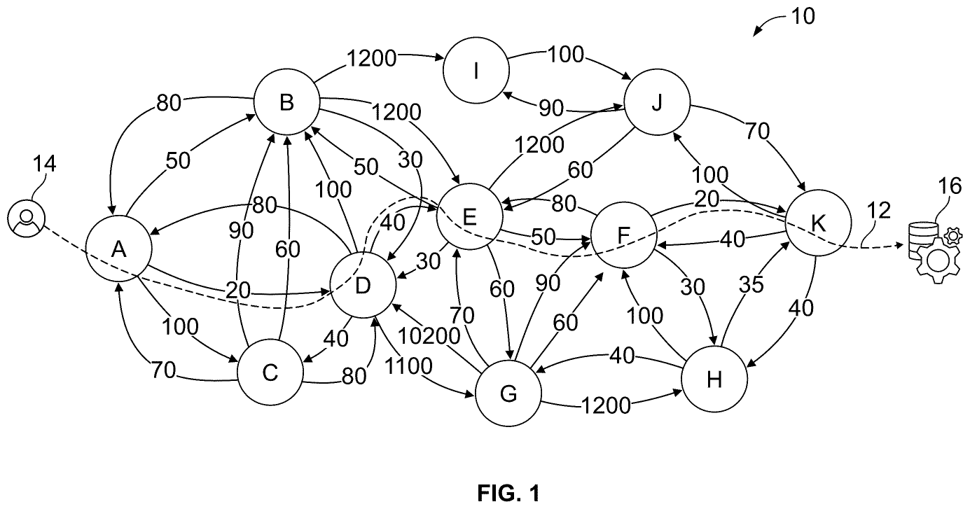

FIG. 1 shows a graphical representation of an exemplary network topology 10. It shows every node in the network as well as the links between the nodes and the cost of each link. In this simple example there are 11 nodes, namely, nodes A through K. Each arrowed line represents a direct communication link between two nodes (i.e., two nodes that can communicate directly with one another without using an intermediate node, sometimes referred to as adjacent nodes). The arrows indicate the directions of the links, and the number in the middle of each line represents the relative cost of the link.

Once the network topology is mapped and known by each node, each node can build a routing information base (often referred to by the acronym RIB or simply referred to as a routing table) which dictates to which other network node the node should transmit a data packet that is either generated at the node (e.g., at one of the devices coupled to the node) or received from another node for relay to yet another node. Particularly, each data packet typically includes within the packet the identity of the destination node and/or device for the packet. The node determines the next hop for the packet (i.e., the next node to which it should transmit the packet) based on the RIB and the destination node. The RIB is largely based on the network topology (including the interconnectivity of the network nodes and the cost associated with each hop). Various algorithms are known for building routing tables. One such algorithm is Dijkstra's Shortest-Path-First algorithm, for instance. This particular algorithm attempts to determine the best route through the network from a given source node to a given destination node based primarily on a combination of the shortest path from the source to the destination and the lowest cost. In addition to the network topology, the exact route that a packet takes through the network may also be dependent upon the content of the packet. For instance, video data may be sent along a different path than a short message or high priority data may travel along a different path than lower priority data. Thus, in some cases, the RIB may identify more than one potential path that the data may take through the network and the ultimate path will be determined by information external of the RIB (e.g., the type of the data or the hardware configuration of the relevant router).

As new nodes are added or old nodes are removed from the network, update messages are exchanged so that all of the nodes can continuously update their picture of the network topology and their respective routing tables.

Referring again to the network topology diagram of FIG. 1, it also demonstrates a route, represented by the dashed line 12 dictated by the RIB for data originating at a first, source device 14 (e.g., a cellular telephone) that connects to the network via network node A and a second, destination device 16 (e.g., a server) that is connected to the network via node K. As can be seen, using an algorithm such as the aforementioned Dijkstra's algorithm, the RIB dictates a path that goes from node A to node D, then from node D to node E, then from node E to node F, and, finally, from node F to node K.

In a common exemplary scenario, a user of the network may attempt to send data (an email, a text message, a video, an html request message, a photograph, a word processing document, etc.) from a device (e.g., a home computer) that is coupled to one node of the network (hereinafter the source node) through the network (e.g., the Internet) to a server device coupled to another node of the network (hereinafter the destination node). Let us say that the message comprised a request for a webpage. If a node that the request passes through or a node that the response thereto passes through is faulty, the user may not receive the requested webpage. That faulty node could have been somewhere in the route of the request message from the user's node to the server's node or in the route of the responding message from the server to the user. Commonly, the user would not be able to determine which. Also, the route that the request message takes from the user to the server could be different from the route of any response from the server to the user. Typically, all the user knows is that he/she did not get the requested webpage.

The incident (i.e., the failure of the user to receive the requested webpage) may not be reported to (or independently discovered by) the network operation for hours, days or even longer. During that delay, the network topology and the routing tables likely have changed many times (e.g., due to nodes being added to or removed from the network or nodes becoming faulty). When the problem is reported (or discovered), the network operator typically will wish to determine which node caused the problem and the cause of the problem, and take appropriate action to prevent the problem from occurring again (e.g., fix, replace, or route traffic around the faulty node). Typically, this task would be assigned to a network analyst who would first determine the path through the network that the failed data packet (or response packet thereto) took through the network in order to minimize the number of nodes that need to be triaged (i.e., typically the problem would be in one of the nodes that the packet traversed).

Commonly, when such an error is reported or discovered, the network analyst will know little or nothing more than the source node and/or device, the destination node and/or device, and, hopefully, the approximate time that the fault occurred. It should be apparent from the discussion above that the task of determining the nodes of the network that the failed message(s) passed through between a given source node and given destination node (not to mention the reverse path, since the fault could have occurred in the path of the response message rather than the path of the request message) in a given time period involves the analysis of a staggering amount of data and, thus, can be extremely time-consuming.

U.S. patent application Ser. No. 18/434,963, owned by Selector Software, Inc., the applicant of the present patent application and incorporated herein in full by reference, discloses one such diagnostic tool. Particularly, it discloses methods, apparatus, systems, and techniques for storing, maintaining, monitoring, and querying a database from which the status of a communication network, including the RIB for the entire network, can be determined and recreated for any given instance in time in the past (or at least as far back in time as the network operator cares to store such data). One use of such a system for historical analysis of a network is for determining and/or diagnosing the cause of detected network errors or performance degradations, such as determining the identity of a faulty network node. More particularly, when one of the nodes of the network is faulty, it may prevent some messages in the network from reaching their intended destination nodes, thereby causing inconvenience (or worse) for users of the network. Since a modern large scale network could easily comprise thousands of nodes (typically comprising a plurality of smaller, heterogeneous topologies), when a message is not received properly at the destination node, it often an extremely challenging task to determine which node in the network is faulty and needs attention.

In order to identify a faulty node, operations teams employed by the network operator must examine the network topology and spot any inconsistencies along the paths from the source device to the destination device, and thereby determine which parts of the network need to be triaged in depth. To further complicate matters, often, network issues are reported hours, days, or weeks after the problem was experienced and, often, are not replicable. U.S. patent application Ser. No. 18/434,963 makes the process of identifying a faulty node much easier.

U.S. patent application Ser. No. 18/600,223, also owned by Selector Software, Inc. and fully incorporated herein by reference, disclose methods, apparatus, systems, and techniques for storing, maintaining, monitoring, and querying a database from which the status of a communication network, including the RIB for the entire network, can be determined, and from which proposed future modifications to a network can be experimentally tested to forecast network operations under such proposed modifications.

As described in both of the aforementioned patents application Ser. Nos. 18/434,963 and 18/600,223, the database must contain information from which the state of the network at a particular instant in time can be recreated, including the RIB for the network at that instant and the topology of the network at that instant.

It should be apparent from the discussion above and in the background section of this specification that the amount of data required to be stored for a large-scale ISP for these purposes can be staggering (e.g., at any given instant in time, the RIB for such a network may comprise about five billion prefixes; and, at least for the U.S. patent application Ser. No. 18/434,963, that RIB is being continuously modified and must be stored for multiple instances in time).

To implement the route lookup necessary to trace the path of any given packet/message through the Internet for purposes of the diagnostics and/or predictive diagnostics as discussed in the aforementioned patents application Ser. Nos. 18/434,963 and 18/600,223, one must know the full Internet routing table of the network and the full network topology.

In order to be able to recreate the network state at any given instant, the system disclosed in those two patents obtains a snapshot (hereinafter sometimes referred to as a RIB snapshot) of the state of the network RIB at a certain instance in time. For instance, such files are well known in the related arts and comprise data that can be used to determine the topology of the network as well as the routing tables for the network at a given instant in time. In an embodiment, the system may obtain such RIB snapshots at various intervals selected to assure that a relatively recent snapshot of the network is always available at any given moment.

Additionally, the system stores records of the updates to the routing and other protocols, such as BGP updates, at smaller intervals between the RIB snapshots, e.g., every ten minutes.

These update reports also are well known in the related arts and, unlike the RIB snapshot, these update files do not comprise information as to the state of the network at any given instant in time, but rather comprise a sequential list of events that occurred in the network (namely, the events that can affect the topology and/or routing tables in the network, such as OSPF, ISIS, and BGP updates).

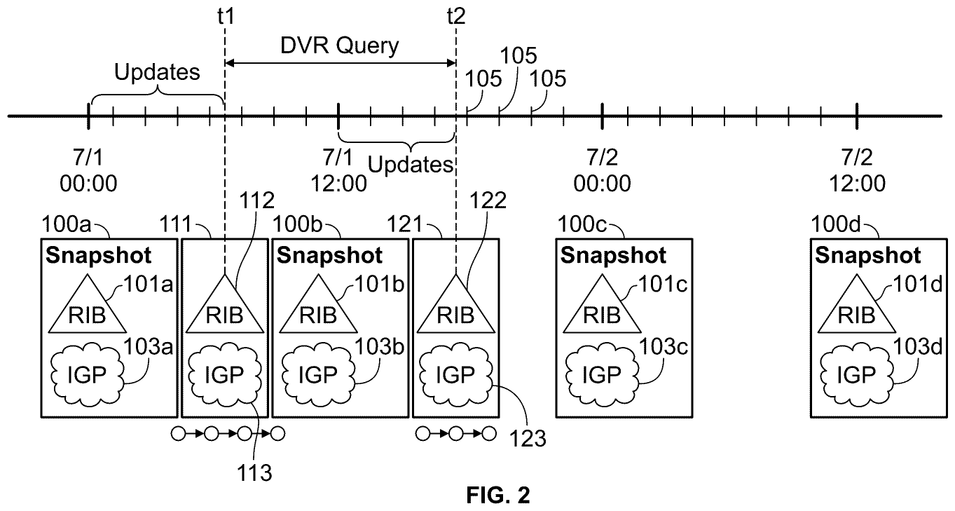

FIG. 2 is a timing diagram graphically illustrating various aspects of an exemplary embodiment of the system described in the two aforementioned patent applications.

As can be seen, the system stores files, e.g., BGP files, provided by the network operator that provide snapshots 100a, 100b, 100c, 100d of the state of the network at various points in time, e.g., at twelve hour intervals. The data in each such file may be considered to comprise two basic forms. The first form is the network RIB at that instant in time, represented by the triangular icons 101a, 101b, 101c, 101d in FIG. 2. The second form is the IGP profile, which is a picture of the topology of the network at that instant in time, represented by the cloud icons 103a, 103b, 103c, 103d in FIG. 2.

In addition, at multiple intervals between each 12 hour snapshot of the network, the system obtains the record of all of the routing protocol updates that occurred between the current update and the immediately preceding update (or the snapshot 100 of the network state in the case of the first update file after a snapshot). In order to keep FIG. 2 from becoming too busy, the updates are represented simply by vertical lines 105, and only some of those updates are labelled with the reference number (105).

Typically, a network analyst analysing a network event will know the source node/device, the destination node/device, a time or a time window in which the event occurred, and the nature of the event (e.g., one device failed to receive an expected response from another device). In order to triage the event (e.g., to determine the node of the network that caused the event to occur and the nature of the fault in the network that caused the event to occur), the network analyst usually will wish to start the analysis by determining the state of the network in the relevant time window.

Thus, the network analyst may input a query to the system comprising the identities of the two nodes and/or devices (i.e., source and destination) between which the event occurred and the time window of interest (e.g., by entering a specific start time and end time) into the system using a suitable graphical user interface.

Responsive to the query, the system will build a picture of the network topology and recreate the RIB(s) at the start time and at the end time of that time window (t1 and t2, respectively, in the example illustrated by FIG. 2) based on the relevant IGP files 100 and update logs 105. It also will implement route lookups that mimic the real network's operation at the start and end times, t1 and t2, to determine the path that a data packet would have taken through the network from the specified source device/node to the specified destination device/node. The system will then generate a report that includes the path and detailed information about each node in the path at times t and t2. In cases in which the analyst knows the time of the event very precisely, the analyst may use a very narrow event window or even a single instant in time. In cases where the time window in which the event occurred is larger, the analyst may start with a broader event window, and, since it is possible that the network topology and RIBs could have been updated at some point in the middle of the event window, the network analyst may zoom in on a smaller and smaller times window (as small as one second) as he/she deems advisable.

More particularly, to recreate the network RIB and topology at time t1, the system retrieves from memory the most recent snapshot, 100a, prior to the start time, t1. It also retrieves from memory all IGP and similar updates between the time of the selected snapshot 100a and the event window start time, t1, by reading all update reports 105 between the time of the stored immediately preceding snapshot, 100a, and the update report 105 immediately subsequent to the event window start time, t1. The system recreates the state of the network at time t1 by taking the RIB and topology contained in the snapshot 100a and sequentially applying all the RIB updates that occurred between that snapshot 100a and the event window start time, t1, to build a new RIB 112 for time t1. Of course, the system will not apply any events contained in the last update report (the report whose time is subsequent to time t1) that occurred after time t1.

In addition, from the time of snapshot 100a to time t1, the system retrieves all the route updates from the relevant update reports 105 and builds a new topology 113 at time t1 by sequentially applying all of those updates up to time t1 to the IGP topology 103a of snapshot 100a.

Now the system has the complete snapshot 111 state of the network at time t1. Then, the system determines the path that a data packet would have traversed through the network between the specified source and destination nodes at time t1, e.g., by applying Dijkstra's shortest-path-first algorithm to determine the shortest path from the source node to the destination node using the RIB 112 that it just constructed.

Then, the system repeats the process for the event window end time, t2, to recreate the state of the network at that time. Particularly, the system retrieves the most recent network snapshot, 100b, prior to the event window end time, t2. (Note that, in an alternate example, if there were no intervening snapshot 100 between the start time, t1, and the end time, t2, then this snapshot would be the same snapshot that was used to recreate the state of the network at the start time.) The system then retrieves all update reports 105 between the time of snapshot 100b and the report immediately subsequent to the end time, t2, and recreates a snapshot 121 of the state of the network (including a RIB 122 and a topology 123) for time t2, exactly as described above for time t1. Further, it determines the path that a data packet would have traversed through the network between the source and destination nodes specified in the query at time t2.

Even further, as previously noted, sometimes, the generated network topology 113 and routing table 112 may reveal that more than one potential path between two nodes was possible at a given instant. If so, the system may show all possible paths in its report. Additionally in such cases, the system may use BGP best path selection algorithm to determine the best path and present the best path in the report along with the alternate paths, the tie-breaker factor between the potential paths, and relevant BGP attributes. This would be useful to the network analyst because the analyst could than choose to examine the most likely path first. For further detail on the above-described systems, one may refer to aforementioned U.S. patent application Ser. No. 18/434,963 and U.S. patent application Ser. No. 18/600,223, both of which have been fully incorporated herein by reference.

While the system disclosed in the two aforementioned patent applications summarized above is extremely efficient, it can be made even more efficient by recognizing that not all of the network updates that occurred between the time of the snapshot and the time of interest are relevant. In fact, only the network updates to the RIB that match the prefix of the destination node specified in a particular query could have affected the route that a packet between the source node and destination node could have taken. Therefore, only those updates are relevant to the query, such that only those particular updates occurring between the relevant snapshot 100 and the time of interest need be considered.

Additionally, the process can be made even more computationally efficient by further recognizing that, while a large scale network, such as the Internet, may have a massive number of updates occurring continuously (e.g. millions of updates in a typical hour time span), very few of them are likely to affect any one particular path between two nodes of the network. In fact, statistically speaking, it is quite possible that the pathway between one particular source node and one particular destination node may not experience any alteration for hours or even days at a time. In such a case, then the routing table and topology acquired from the most recent snapshot preceding the time of interest can be used directly to determine the pathway between the source and destination nodes at the time of interest without the need to process any updates at all between the time of the snapshot and the actual time of interest.

Thus, in accordance with an embodiment, as before, the system may obtain and store files, such as BGP files, disclosing the state of the network (the RIB and topology of the network) at one or more instants in time (i.e., the aforementioned “snapshots” 100), e.g., every 12 hours.

Also as previously described, the system may store reports 105 of updates to the routing and other protocols, such as OSPF, ISIS, and BGP, at smaller intervals between the snapshots, e.g., every ten minutes. Only updates that could affect the RIB are needed for this embodiment, and, hence, in certain embodiments, only the types of updates that can affect routing may be stored.

The system receives a query specifying the identities of two nodes and/or devices (i.e., source and destination) between which the user wishes to determine the path a data packet could have taken through the network and one or more times (e.g., a single instant of time of interest or a start time and end time of a window of interest) via a suitable graphical user interface. For purposes of this example, let us assume that there is a single instant of time that is of interest. However, it will be understood that, in cases where the time of interest is a window of time, the process would be repeated for the start time and end time of the window as described hereinabove.

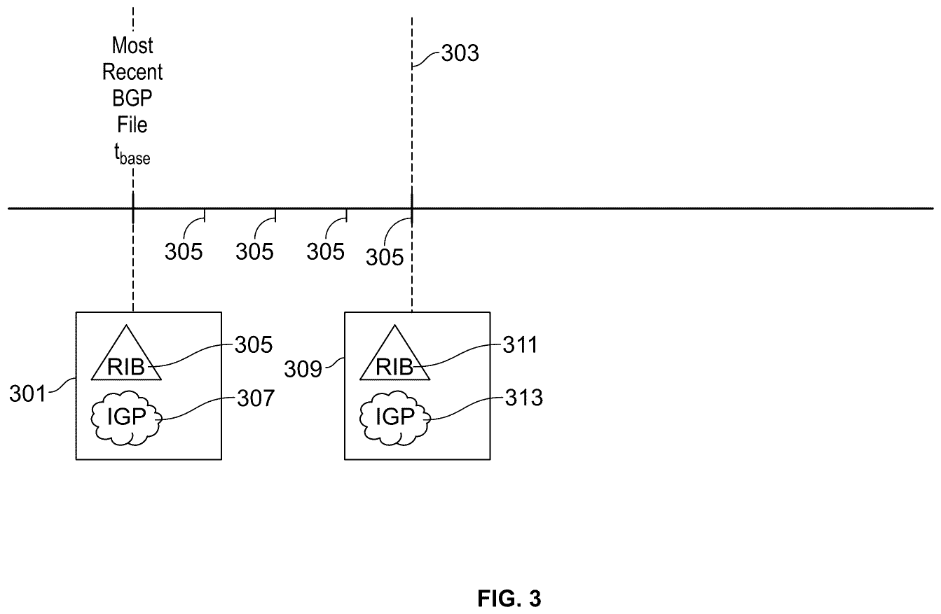

With reference to FIG. 3, which is a timing diagram graphically illustrating various aspects of an exemplary embodiment of the system, responsive to the query, the system retrieves from memory the most recent network snapshot 301 prior to the time of interest 303. It also retrieves from memory all of the update reports 305 between the time of the selected snapshot 301 and the time of interest.

In order to simplify the diagram and discussion, time 303 is shown as corresponding exactly with the time of one of the update reports 305. However, it will be understood that, just as described above, if the time of interest does not correspond exactly with the time of one of the update reports 305, then the system will retrieve all updates reports since the time of the selected snapshot 301 up to the update report immediately succeeding the time of interest, but will discard any updates contained in that last update report whose time is subsequent to time 303.

Next, from the retrieved updates, the system selects only those updates that match the prefix of the destination node specified in the query. Then, the system performs Longest Prefix Matching (LPM) directly on the sequence of selected updates (rather than applying those selected updates to the RIB snapshot 305 to build a new snapshot) and determines the one or more bestpaths along with nexthops and BGP path attributes for a data packet transmitted from the source node to the destination node specified in the query.

More particularly, the system maintains a Global Internet Prefixes (GIP) table. A GIP table is a table of the well-known Internet prefixes. Note that a GIP table is not tied to any particular time or snapshot, but is the steady state of an Internet prefix list, without the notion of nexthops. However, whenever nodes are added or removed from the Internet, this table is updated accordingly.

The system determines which ones of the potentially millions of updates found in the one or more update reports 305 between the time of the preceding snapshot 305 and time 303 are relevant to nodes in the path between the source and destination nodes specified in the query by searching the GIP table for only those updates with prefixes that match the prefix of the destination node specified in the query. Note that this step is not limited to looking only for the longest match, but for all prefix matches for the destination address. Thus, this search will result in a list of prefixes matching the destination address prefix.

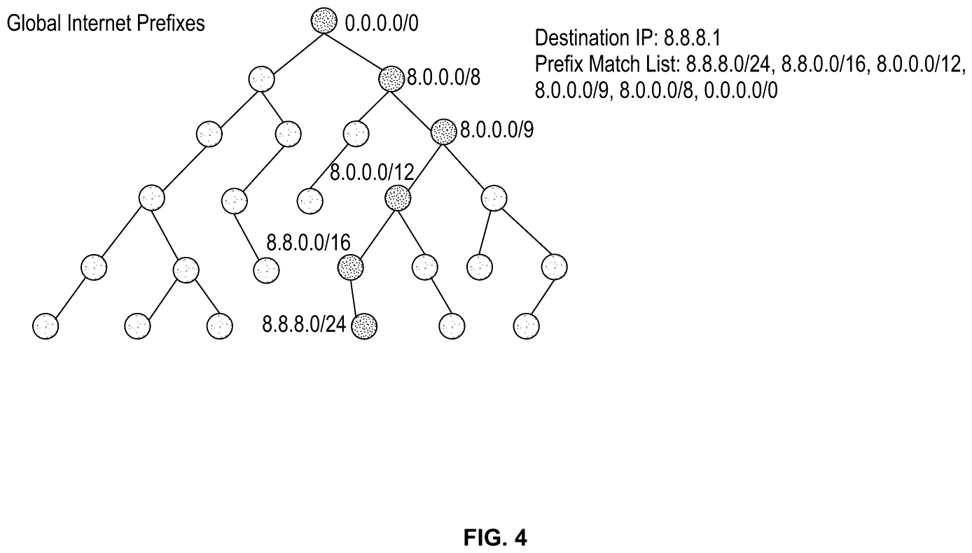

FIG. 4 is a graphical representation of at least a portion of the information stored in the GIP table that helps illustrate this concept. Note that, while this information is not typically stored in this form in a GIP, FIG. 4 helps illustrate the fact that the Internet prefixes are organized in a binary tree-type structure, such that all matching prefixes for any given DIP will appear in a single continuous leg of the tree. That is, all of the matching prefixes will be in the same path between the top level of the tree, e.g., prefix 0.0.0.0/0, and the lowest level (commonly referred to at the leaf level), e.g., prefix 8.8.8.0/24. Also note that the number appearing after the slash in the prefix is the length of the prefix. For instance, if the destination address is Google IP, e.g., 8.8.8.1, it results in six prefix matches, such as illustrated by the darkened nodes in FIG. 4.

Certain commonly available off-the-shelf databases APIs (Application Program Interfaces) support such searching by prefix. For instance, Postgres has the “>>=” match function which can be used for such searching. For other databases that do not inherently support searching by prefix, suitable modification to the software to enable such searching would be easy to develop.

Next, the system compares the bestpath(s) determined based on the preceding snapshot RIB 305 with any matching updates to determine if any of those updates could have altered a nexthop or a path attribute in any of those bestpath(s). If so, then the system executes another LPM operation on the selected sequence of updates and determines the one or more bestpaths along with nexthops and BGP path attributes for the source and destination nodes specified in the query.

Particularly, if the bestpath determined using the data from the snapshot 305 has, for instance, been withdrawn, then the system selects the bestpath(s) determined based on the updates. Also, if the bestpath(s) determined based on the selected sequence of updates includes a prefix that was advertised that is longer than the longest prefix in the unaltered snapshot 301, then the system will use that length rather than the length based on the snapshot 301.

Finally, as previously noted, sometimes this process may return more than one possible bestpath. As previously noted, in such cases, the system may be configured to show all possible paths in its report. Additionally in such cases, the system may use BGP best path selection algorithm to determine the best path and present the best path in the report along with the alternate paths, the tie-breaker factor between the potential paths, and relevant BGP attributes.

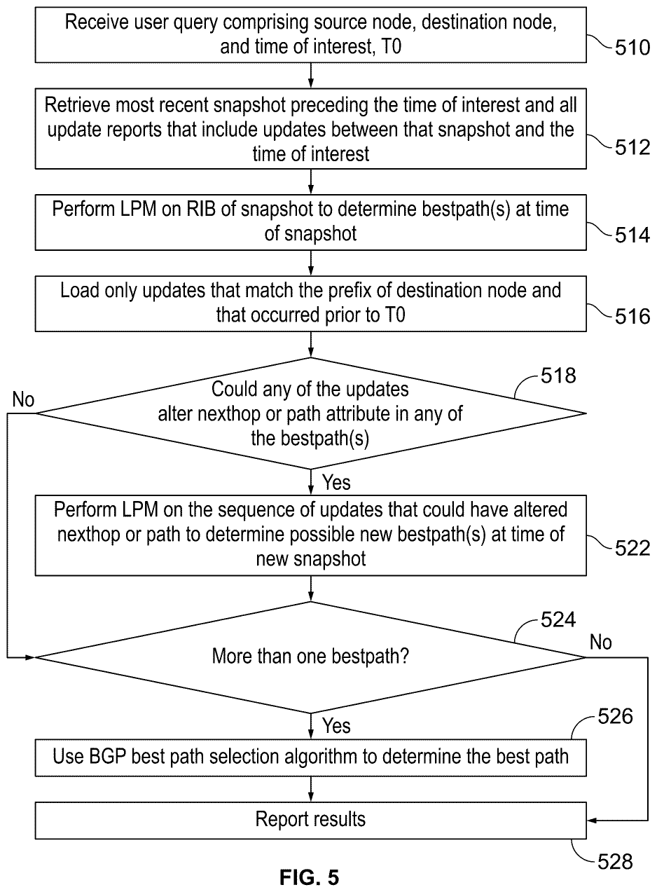

FIG. 5 is a flowchart illustrating operation of the system in accordance with one exemplary embodiment.

At step 510, the system receives a query specifying the identities of two nodes and/or devices (i.e., a source and a destination) between which the user wishes to determine the path a data packet would have taken through the network and at least one time of interest, T0. (It will be understood that, in cases where the time of interest is a window of time, the process would be repeated for the start and end times of the window).

At step 512, the system retrieves the most recent network snapshot prior or equal to the time of interest. It also retrieves all of the update reports potentially containing RIB updates between the time of the selected snapshot and the time of interest. As previously noted, this involves retrieving all update reports between the time of the retrieved snapshot and the update report with a time stamp equal to or immediately succeeding the time of interest, T0.

In step 514, the system performs LPM directly on the RIB of the retrieved snapshot to determine the one or more bestpaths, along with nexthops and BGP path attributes, for a data packet transmitted from the source node to the destination node specified in the query at the time of the snapshot.

In step 516, the system loads only those updates from the retrieved update report(s) that (1) match the prefix of the destination node specified in the query and (2) occurred prior to the time of interest, T0.

In step 518, the system compares the bestpath(s) determined based on the nearest preceding snapshot (step 514) with any matching updates and determines if any of those updates could have altered a nexthop or a path attribute in any of those bestpath(s). If not, then the bestpath(s) determined in step 514 would not have changed between the time of that snapshot and the time of interest, T0. Accordingly, it is not necessary to recalculate the bestpath(s) determined in step 514. Thus, flow skips over step 522 to step 524 (described further below).

If, on the other hand, it is determined in step 518 that there were updates that could have altered the bestpath(s) determined in step 514, then flow proceeds to from step 518 to step 522, in which the system applies LPM to only those updates and determines the one or more bestpaths along with nexthops and BGP path attributes for the source and destination nodes specified in the query.

For instance, if the bestpath(s) determined using the data from the unaltered snapshot has(ve) been withdrawn, then the system selects the bestpath(s) determined by applying LPM to the selected sequence of updates. Also, if the LPM on the updates reveals a prefix that was advertised that is longer than the longest prefix determined from the unaltered snapshot, then the system will use that length rather than the length of the current path.

Finally, as previously noted, sometimes this process may return more than one possible bestpath. Thus, in step 524, the system determines if there are more than one possible bestpath has been identified. If so, flow proceeds to step 526, where it uses a best path selection algorithm to determine the most likely best path from the multiple potential paths. If the LPM presents only a single bestpath, then flow skips step 526 and proceeds directly to step 528.

In step 528, the system generates a report identifying the best path (along with other relevant information about the nodes in the path as well as additional information such as discussed hereinabove and/or in aforementioned patents application Ser. Nos. 18/434,963 and 18/600,223. For instance, such a report may include detailed information about the nodes in the path and, if there were multiple bestpaths at step 524, the report may include a list of all such bestpaths along with an indication of which one of those multiple bestpaths was determined to be the most likely bestpath at step 524.

It should be noted that, while the exemplary embodiments have mostly been described in connection with a scenario in which a network analyst is attempting to track down the particular node of a fault in the network, it can be equally applied to other scenarios, including the scenario that is the focus of aforementioned U.S. patent application Ser. No. 18/600,223, in which the analyst wants to test the potential effect on a network of a contemplated change to the network on a particular pathway between two specific nodes of the network.

Table 1 shown and discussed below is exemplary code (in PYTHON and PANDAS) for implementing the route resolution sub-process (steps 514 and/or 522) that might be performed in step 522.

```
TABLE 1
PROCESS 1
/* Determine all matching paths from the previous snapshot route table */
best_paths = route_lpm_lookup(snapshot_table, destination_address)
PROCESS 2
/* Load matching updates from snapshot-time to dvr-start-time */
updates = db_read(snapshot_time, dvr_time, destination_address)
PROCESS 3
/* Mark snapshot best paths as ‘advertised’ and concatenate with
updates */
best_paths[′type′] = ′A′
combined_paths = updates.append(best_paths)
combined_paths[′valid′] = True
PROCESS 4
/* Iterate and invalidate withdrawn prefixes */
for path in combined_paths.itertuples( ):
  if path.valid is False: continue
  /* If prefix is withdrawn: Invalidate subsequent <rd, prefix> paths */
  if path.type == ′W′:
    combined_paths.loc[(combined_paths[′prefix′] == path.prefix) &
(combined_paths[′rd′] == path.rd), ′valid′] = False
PROCESS 5
/* Drop invalid paths and consider the rest */
valid_paths = combined_paths[combined_paths.valid == True]
PROCESS 6
/* If none left, snapshot match prefix is withdrawn and there's no path */
if valid_paths.empty:
  return None
PROCESS 7
/* Sort and consider all the best paths (longest matches) */
valid_paths.sort_values(′prefix_len′, ascending=False, inplace=True)
longest_len = valid_paths.iloc[0][′prefix_len′]
final_paths = valid_paths[valid_paths[′prefix_len′] == longest_len]
PROCESS 8
/* One more paths ready for BGP best-path selection in next step */
return final_paths
```

In the first process, the system makes an API call seeking the best path through the network based on the RIB from the most recent preceding snapshot and the destination address identified in the query. Note that the particular “snapshot table” is a function of the most recent snapshot preceding the time of inquiry and the source node identified in the query.

In the second process, the system loads all of the updates from the update reports 105 between the time of the snapshot and the time identified in the query that have a prefix matching the prefix of the destination node identified in the query.

In the third process, the system updates the list of bestpaths as needed based on the updates loaded in the second process.

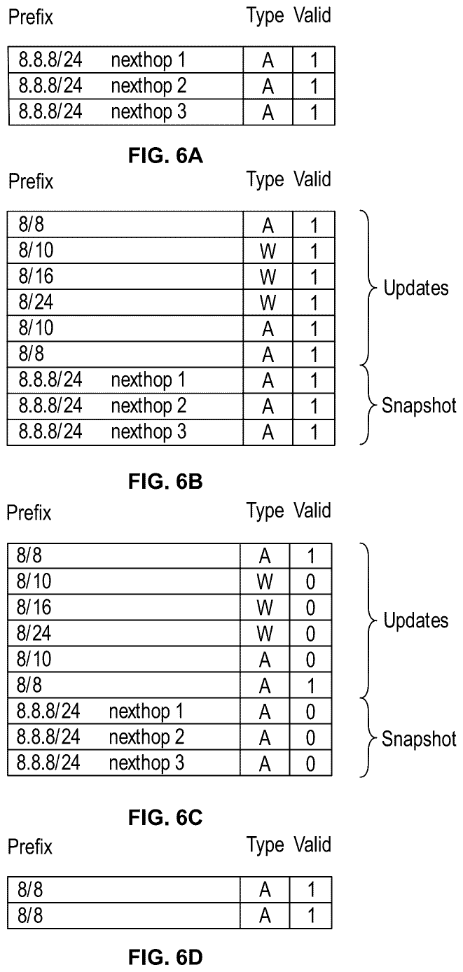

More particularly, first, the system creates a table of all bestpaths identified in the first process. FIG. 6A, shows such an exemplary table. In this example, it includes three potential paths, each with a destination prefix of 8.8.8/24, wherein each discloses a different nexthop, herein identified for ease of reference as simply nexthop 1, 2, and 3, respectively.

For each path in the table, the table also lists a Type (e.g., either A for advertised (i.e., active) or W for withdrawn (invalid). It also lists for each path whether the path is still valid. At this stage, all of the paths are initially marked as both advertised (indicated by an A in the second column 2) and valid (indicated by a 1 in the third column).

Next, as shown in FIG. 6B, the system appends all of the relevant updates loaded in the second process to the top of the table in time order with the more recent updates being above the less recent updates.

Note that some of the updates will indicate that the node to which the update applies is still available (i.e., active or advertised), while other updates cause the node to be withdrawn. This is indicated in the Type column by an A (for advertised) or a W (for withdrawn). All of the updates are initially marked as valid in the third column.

In the fourth process, the system then examines the Type column of each entry, and, for each entry that is marked withdrawn, it changes the value in the third column to invalid (indicated by a 0). The system also marks as invalid any other entry in the table having the exact same prefix as another entry in the table that is marked as withdrawn. This is shown in FIG. 6C. Note, for instance, that the fifth entry from the top has been marked as invalid even though its Type is A because it has the exact same prefix as the second entry, which is marked as withdrawn. Also, all of the original paths from the snapshot have also been marked invalid because they share the same prefix as the fourth entry, which also is marked as withdrawn.

In the fifth process, the system drops all of the invalid paths from the table. This is shown in FIG. 6D. There are two remaining potential bestpaths in this example.

In the sixth process, if there were no remaining paths available, then the system will return a result indicating that there were no paths from the source node to the destination node at the time specified in the query.

In the seventh process, if there are any remaining bestpaths in the table, the system sorts them by prefix length and selects the one(s) with the longest prefix.

Finally, in the eighth process, if there are two or more remaining bestpaths with the same length, then the paths are run through a bestpath selection algorithm as previously discussed to determine which one was the most likely one to be selected by the network.

### CONCLUSION

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), quantum computer, and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. A non-transitory computer-readable medium comprising executable programming instructions stored thereon, which, when executed by a processor, cause the processor to perform operations, the operations comprising:
receiving a query identifying a source device in a communication network, a destination device in the communication network, and a time of interest, T1;
accessing a snapshot of a state of the communication network at a time, T0, preceding the time of interest, the snapshot comprising a topology of the communication network and a Routing Information Base (RIB) of the communication network at time T0;
generating, based on the snapshot of the communication network, a RIB and a topology of the communication network at time T0;
determining, based on the generated RIB and topology of the communication network, one or more potential paths through the communication network that a data packet intended for transmission from the source device to the destination device could have traversed;
accessing a set of network updates, the set of network updates comprising all updates to the topology and RIB of the communication network that occurred between time T0 and time T1 that have a prefix matching a specified portion of a prefix of the destination device;
determining if any of the accessed network updates could have altered a nexthop or path attribute of a node in the one or more potential paths;
if it was determined that one or more of the accessed network updates could have altered a nexthop or path attribute of a node in the one or more potential paths, applying Longest Prefix Matching (LPM) on only those of the determined network updates that could have altered a nexthop or path attribute of a node in the one or more potential paths to identify possible updated paths through the communication network that a data packet intended for transmission from the source device to the destination device could have traversed;
if it was determined that one or more of the accessed network updates could have altered a nexthop or path attribute of a node in the one or more potential paths, determining one or more potential substitute paths through the communication network that a data packet intended for transmission from the source device to the destination device could have traversed; and
if it was not determined that one or more of the accessed network updates could have altered a nexthop or path attribute of a node in the one or more potential paths, determining, based on the RIB and topology of the communication network of the snapshot, one or more potential paths through the communication network that a data packet intended for transmission from the source device to the destination device could have traversed.

2. The non-transitory computer-readable medium of claim 1 wherein the operations further comprise:
generating a report indicating one or more best paths that a data packet intended for transmission from the source device to the destination device could have traversed in the network at time T1, the one or more best paths being the one or more potential substitute paths, if one or more substitute paths were determined, and the one or more best paths being the one or more potential paths if no substitute paths were determined.

3. The non-transitory computer-readable medium of claim 2 wherein the report further comprises at least an ordered list of the network nodes in the one or more best paths.

4. The non-transitory computer-readable medium of claim 3 wherein the operations further comprise:
storing snapshots of the state of the network at intervals of a first duration; and
storing, at second intervals smaller than the first intervals, update reports, wherein each update report comprises updates that occurred between a time of the immediately preceding snapshot or the immediately preceding update report and the current update report.

5. The non-transitory computer-readable medium of claim 4 wherein the operation of accessing the snapshot of a state of the communication network preceding time T1 comprises accessing the most recent stored snapshot of the communication network preceding time T1.

6. The non-transitory computer-readable medium of claim 5 wherein the first interval is between 6 and 24 hours and the second interval is between 5 and 30 minutes.

7. The non-transitory computer-readable medium of claim 5 wherein the first interval is 12 hours and the second interval is 10 minutes.

8. The non-transitory computer-readable medium of claim 2, further comprising the operation of, if more than one best path was determined, executing a BGP best path algorithm to select a one of the more than one best paths that was most likely, and wherein the operation of generating the report further comprises indicating the selected best path.

9. The non-transitory computer-readable medium of claim 8, wherein the operations further comprise:
determining one or more paths through the communication network that a data packet intended for transmission from the destination device to the source device could have traversed at time T1.

10. The non-transitory computer-readable medium of claim 1 wherein the operation of determining, based on the selected sequence of updates, one or more substitute paths through the communication network that a data packet intended for transmission from the source device to the destination device could have traversed comprises:
creating a table of the one or more potential best paths determined based on the updates, wherein each entry in the table comprises (1) the corresponding path, including a destination prefix and a nexthop, (2) a type value, and (3) a validity value, wherein the type value indicates whether the corresponding path is advertised or withdrawn and the validity value indicates whether the path is valid or invalid;
initially designating each entry in the table as being both advertised and valid;
appending to the table all the accessed updates that could have altered a nexthop or path attribute of a node in the one or more potential paths in order of a time of the update with the most recent update at the top of the table, each update including a prefix corresponding to the node of the network to which the update pertains, and wherein each update in the table that withdrew a node from the network is assigned a type value of withdrawn and each update in the table that did not withdraw a node from the network is assigned a type value of advertised, and wherein each update is initially assigned a validity value of valid;
for each entry in the table that is assigned a type value of withdrawn and each entry in the table that has a same prefix as the prefix of an entry that is assigned a type value of withdrawn, changing the corresponding valid value to invalid;
eliminating from the table all entries assigned a validity value of invalid; and
if there are any entries remaining in the table, selecting the entry(ies) with the longest prefix as the one or more best paths.

11. A method of determining a path that a data packet could have taken through a communication network at a time of interest comprising:
receiving a query identifying a source device in a communication network, a destination device in the communication network, and a time of interest, T1;
accessing a snapshot of a state of the communication network at a time, T0, preceding the time of interest, the snapshot comprising a topology of the communication network and a Routing Information Base (RIB) of the communication network at time T0;
generating, based on the snapshot of the communication network, a RIB and a topology of the communication network at time T0;
determining, based on the generated RIB and topology of the communication network, one or more potential paths through the communication network that a data packet intended for transmission from the source device to the destination device could have traversed;
accessing a set of network updates, the set of network updates comprising all updates to the topology and RIB of the communication network that occurred between time T0 and time T1 that have a prefix matching a specified portion of a prefix of the destination device;
determining if any of the accessed network updates could have altered a nexthop or path attribute of a node in the one or more potential paths;
if it was determined that one or more of the accessed network updates could have altered a nexthop or path attribute of a node in the one or more potential paths, applying Longest Prefix Matching (LPM) on only those of the determined network updates that could have altered a nexthop or path attribute of a node in the one or more potential paths to identify possible updated paths through the communication network that a data packet intended for transmission from the source device to the destination device could have traversed;
if it was determined that one or more of the accessed network updates could have altered a nexthop or path attribute of a node in the one or more potential paths, determining one or more potential substitute paths through the communication network that a data packet intended for transmission from the source device to the destination device could have traversed from the one or more potential substitute paths; and
if it was not determined that one or more of the accessed network updates could have altered a nexthop or path attribute of a node in the one or more potential paths, determining, based on the RIB and topology of the communication network of the snapshot, one or more potential paths through the communication network that a data packet intended for transmission from the source device to the destination device could have traversed.

12. The method of claim 11 further comprising:
generating a report indicating one or more best paths that a data packet intended for transmission from the source device to the destination device could have traversed in the network at time T1, the one or more best paths being the one or more potential substitute paths, if one or more substitute paths were determined, and the one or more paths being the one or more one potential paths if no substitute paths were determined.

13. The method of claim 12 wherein the report further comprises at least an ordered list of the network nodes in the one or more best paths.

14. The method of claim 13 further comprising:
storing snapshots of the state of the network at intervals of a first duration; and
storing, at second intervals smaller than the first intervals, update reports, wherein each update report comprises updates that occurred between a time of the immediately preceding snapshot or the immediately preceding update report and the current update report.

15. The method of claim 14 wherein accessing the snapshot of a state of the communication network preceding time T1 comprises accessing the most recent stored snapshot of the communication network preceding time T1.

16. The method of claim 15 wherein the first interval is between 6 and 24 hours and the second interval is between 5 and 30 minutes.

17. The method of claim 15 wherein the first interval is 12 hours and the second interval is 10 minutes.

18. The method of claim 12, further comprising:
if more than one best path was determined, executing a BGP best path algorithm to select a one of the more than one best paths that was most likely, and wherein the operation of generating the report further comprises indicating the selected best path.

19. The method of claim 18, further comprising:
determining one or more paths through the communication network that a data packet intended for transmission from the destination device to the source device could have traversed at time T1.

20. The method of claim 11 wherein of determining, based on the selected sequence of updates, one or more substitute paths through the communication network that a data packet intended for transmission from the source device to the destination device could have traversed comprises:
creating a table of the one or more potential best paths determined based on the updates, wherein each entry in the table comprises (1) the corresponding path, including a destination prefix and a nexthop, (2) a type value, and (3) a validity value, wherein the type value indicates whether the corresponding path is advertised or withdrawn and the validity value indicates whether the path is valid or invalid;
initially designating each entry in the table as being both advertised and valid;
appending to the table all the accessed updates that could have altered a nexthop or path attribute of a node in the one or more potential paths in order of a time of the update with the most recent update at the top of the table, each update including a prefix corresponding to the node of the network to which the update pertains, and wherein each update in the table that withdrew a node from the network is assigned a type value of withdrawn and each update in the table that did not withdraw a node from the network is assigned a type value of advertised, and wherein each update is initially assigned a validity value of valid;
for each entry in the table that is assigned a type value of withdrawn and each entry in the table that has a same prefix as the prefix of an entry that is assigned a type value of withdrawn, changing the corresponding valid value to invalid;
eliminating from the table all entries assigned a validity value of invalid; and
if there are any entries remaining in the table, selecting the entry (ies) with the longest prefix as the one or more best paths.
